(19) United States
(12) Patent Application Publication
(10) Pub. No.: US 2003/0062205 A1
(43) Pub. Date: Apr. 3, 2003

(54) Vehicle featuring a main drive engine, a compressor and a current source and method for operating the vehicle

(75) Inventors: Gerhard Konrad, Ulm (DE); Manfred Stute, Esslingen (DE); Karl-Heinz Unser, Muggensturm (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/251,199

(22) Filed: Sep. 20, 2002

(30) Foreign Application Priority Data
Sep. 28, 2001 (DE) DE 101 48 213.2

(51) Int. Cl. B60K 6/00

(52) U.S. Cl. 180/65.2; 180/165

(57) ABSTRACT

A vehicle is equipped, inter alia, with a main drive engine, an electric motor, an air compressor and with an electric current source. To permit an energy-optimized, functional operation of the air compressor, the air compressor is driven by the main drive engine provided the main drive engine is running at sufficient speed, or otherwise, as required, by an electric motor, for example, via a power take-off transmission. In this context, the air compressor provides the process air required for the operation of a fuel cell that also supplies the electric motor.

Priority to German Patent Application No. 101 48 213.2, filed Sep. 28, 2001 and hereby incorporated by reference herein, is claimed.

### SUMMARY OF THE INVENTION

The present invention relates generally to a vehicle and a method for operating the vehicle, and more particularly, to a passenger or commercial vehicle and a method for operating such a vehicle.

In the case of vehicles of this kind, in particular, in passenger or commercial vehicles (see German Patent No. 36 01 176 C1), it is known to use an internal combustion engine as the main drive engine, the internal combustion engine driving the vehicle wheels. On the other hand, an independently drivable air compressor or compressor is provided to supply a pneumatic ride-height control. The air compressor is supplied with electric current only under certain conditions, for example, when the internal combustion engine is at rest and the vehicle is loaded and therefore the intention is to re-adjust the ride-height before the main drive engine is started again.

### BRIEF SUMMARY OF THE INVENTION

An object of the present invention is to take measures in a vehicle which permit an energy-optimized, functional operation of the air compressor.

The present invention thus provides a vehicle, in particular, a passenger or commercial vehicle, comprising a main drive engine, an air compressor which is drivable by an electric motor, and an electric current source from which the electric motor is supplied, wherein selectively, the air compressor (9) is drivably connected to the main drive engine (1) or to the electric motor (6).

A method for operating the vehicle is also provided, wherein the air compressor (9) is selectively driven by the main drive engine (1) or by the electric motor (6).

In a vehicle designed according to the present invention, the air compressor can always be driven by the driving power supplied by the main drive engine while the main drive engine is running so that no additional electrical or mechanical conversion losses occur as are unavoidable when driven by a separate electric motor. To tap motive power from the drive train that drives the vehicle wheels, a power take-off transmission can be used via which the air compressor is drivably connected to the main drive engine. Apart from an output drive for the air compressor and a first input drive for the coupling to the main drive engine as needed, this transmission also has a second input drive which, when required, is drivably connected to the electric motor for the air compressor.

In the power take-off transmission, provision is made for coupling devices by which the drive connection of the compressor is automatically shifted from the main drive engine to the electric motor when the main drive engine is at rest or even already at very low rotational speeds below a predetermined minimum speed value if the intention is for the air compressor to maintain functions in the vehicle that are necessary for operation. Then, the electric motor does not have to be already turned on but needs to be activated by suitable control means only when, for example, compressed air is demanded for air consumers. This can be necessary when a previously filled air reservoir is not large enough to supply, for example, pneumatic brake systems or ride-height control systems for a longer period of operation. If, instead of a battery, a fuel cell is used as a current source, the fuel cell being able, for example, to supply the entire vehicle electrical system with electric energy, then it is particularly advantageous to use the air compressor also to provide the required oxygen-containing process air required for the operation of the individual cells of the fuel cell and/or for a possible reformer. In this context, the fuel cell can also be arranged in a fuel cell system which can also be equipped with a usual gas generation system provided with a reformer in which a hydrogen-rich reformate is obtained from a fuel. In this context, the fuel cell at the same time delivers the electric current for driving the electric motor, which drives the air compressor instead of the main drive engine, which will allow continuous operation of the vehicle electrical system and also of the air compressor, unlike when using a battery as the current source. Furthermore, it is possible for the power take-off transmission to be designed as a part of the manual transmission located in the drive train between the main drive engine and the vehicle wheels.

### BRIEF DESCRIPTION OF THE DRAWINGS

In the following, the present invention will be explained in greater detail with reference to a drawing. In this context,

FIG. 1 is a schematic diagram of a system according to the present invention; and

FIG. 2 shows a preferred embodiment of the present invention featuring an auxiliary air compressor.

### DETAILED DESCRIPTION

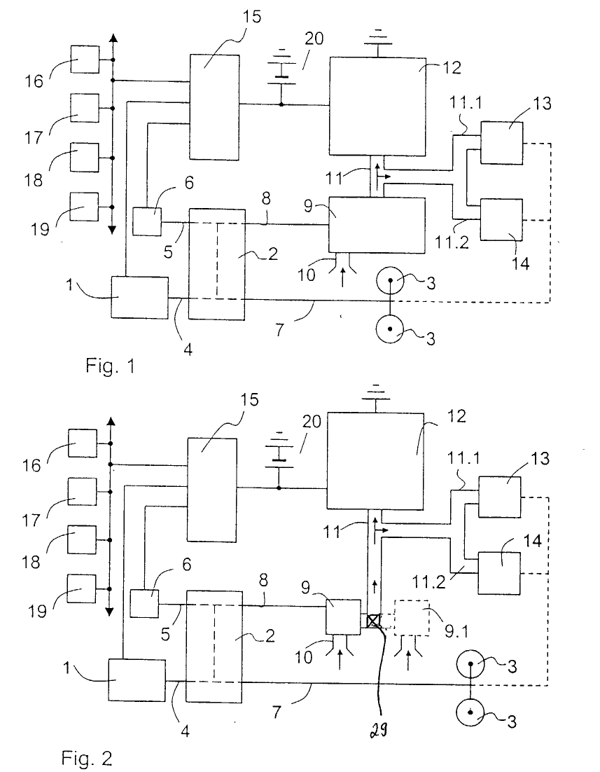

FIG. 1 depicts a vehicle, in particular, a passenger or commercial vehicle for operation on road or rail, featuring a main drive engine 1 which is designed as an internal combustion engine or as an electric traction motor. Main drive engine 1 can be drivingly connected to a pair of vehicle wheels 3 via a drive train featuring an interposed transmission 2 and, possibly, a clutch. Transmission 2 is designed as a power take-off transmission 2 which is drivably connected to main drive engine 1 via a first input drive 4 and, via a second input drive 5, to an additional drive motor, in particular, to an electric motor 6. In addition, power take-off transmission 2 can be provided with a first output drive 7 which is coupled to vehicle wheels 3. Moreover, power take-off transmission 2 features a second output drive 8 via which an air compressor 9 is driven. Air compressor 9 sucks in atmospheric air containing a proportion of oxygen from the environment and delivers it as process air via a compressed-air line 11 to a fuel cell 12, which serves as the current source, to supply oxygen for the electricity generation process. Moreover, the compressed air can be used via branch lines 11.1 and 11.2 for compressed air supply to pneumatic brake systems 13 and air suspension systems or ride-height control systems 14 which can be used to brake vehicle wheels 3 or to operate the vehicle suspension system, respectively.

Fuel cell 12 produces electric current in a demand-controlled manner, the current being fed to an electrical control system 15. Control system 15 is used to control electric motor 6, main drive engine 1 and power take-off transmission 2 and can also supply, control or charge further electrical control devices or loads such as lights 16, seat heaters 17, defroster systems 18, air conditioning and ventilation systems 19 as well as other electrical loads, and also fuel cell 12 as well as a battery 20, which is used, in particular, to start fuel cell 12.

In the case of this design, air compressor 9 is controlled in such a manner that during normal driving operation of the vehicle with running main drive engine 1, air compressor 9 is driven via power take-off transmission 2 and supplies the necessary air consuming parts (fuel cell 12, brake system 13, ride-height control system 14) with the required quantity of air. However, if main drive engine 1 is turned off or running at a rotational speed which is below a predetermined minimum value and no longer guarantees supply of the required quantity of air, electric motor 6 is started. Then, electric motor 6 drives air compressor 9 directly via power take-off transmission 2, the remaining drive train being decoupled with respect to electric motor 6. In special or emergency cases, however, electric motor 6 can also be used for additional drive of vehicle wheels 3, or possibly to drive the wheels alone when main drive engine 1 is disengaged. The electric energy for additional drive motor 6 is supplied from fuel cell 12, which preferably powers the entire electrical system of the vehicle.

Moreover, it is possible for the air compressor to be operated by electric motor 6 independently of the drive engine also in the case of excessive speeds of the drive engine. This makes it is possible to improve consumption.

Particularly large potential savings result if the air compressor is driven by the drive engine during an overrun phase in the manner of an “engine brake” so that no fuel is consumed to provide the compressed air. In the traction phase, air compressor 9 can subsequently be driven by electric motor 6 as required. In this context, the drive can be via driven engine 1 or electric motor 6 during traction.

The air compressor preferably delivers the compressed air for the brake system, the air suspension and/or the ride-height control of the vehicle. Air compressor 9 is preferably driven by drive engine 1 in the normal case and by electric motor 6 when the speed of drive engine 1 is too low or during a standstill.

Altogether therefore, this results in an energy-optimized operation of air compressor 9 which is driven by main drive engine 1, which is running anyway, during driving operation, and which, only when the main drive engine is at rest or running too slow, is driven as required by an additional drive motor 6 which has lower losses than idling main drive engine 1.

Besides air compressor 9, an auxiliary, preferably electromotively driven air compressor 9.1 can be provided. This is schematically depicted in FIG. 2 by air compressor 9. 1, which is shown in broken lines. Components identical to those in FIG. 1 are denoted by the same reference numerals. Auxiliary air compressor 9.1 makes it possible to ensure a dual circuit design of the compressed air generation. If one air compressor 9 or 9.1 fails, the other air compressor 9.1 or 9 can supply the compressed air system with compressed air. Air compressor 9 and auxiliary electromotively driven air compressor 9.1 can, in cases, be connected in series with respect to compressed-air line 11. Then, preferably, a non-return valve 29 is provided in the connecting line between the two air compressors.

It is beneficial to provide an additional electric motor for driving air compressor 9.1. However, the drive can also be via electric motor 6 using a suitable drive connection such as a preferably disengageable belt drive or the like. This auxiliary electromotively driven air compressor 9.1 can preferably be switched on independently of air compressor 9. This permits dual circuit compressed air generation. It is an advantage that this auxiliary air compressor 9.1 can be switched as required, for example, in the case of an additional demand of compressed air for braking or, for instance, when actuating lifting mechanisms of the vehicle which are supplied with compressed air.

When drive engine 1 is at rest, this auxiliary air compressor 9.1 can be switched on, for example, depending on the vehicle system voltage and/or on the driver's request and/or on the pressure level of the compressed air system.

This refinement of the system according to the present invention has the advantage that a dual circuit compressed air generation is able to guarantee a compressed air generation of the vehicle, for example, in emergency operation, in case of a failure of one compressed air source. Moreover, a high air compressor output is possible via electromotively driven air compressor 9.1 already at low engine speeds of main drive engine 1 or even without the drive engine operating.

Advantageously, air compressor 9, which is driven by the drive engine and preferably optimized in terms of demand and performance, is rated according to the compressed air consumption to be expected during normal driving operation and can therefore be energy-optimized, for example, via the main driving portions of a vehicle. In case of an additional demand exceeding this compressed air consumption to be expected, the auxiliary electromotively driven air compressor 9.1 can be switched on and thus guarantee a sufficient compressed air supply, for example, while driving downhill, which involves a high compressed air consumption during braking.

In case of an additional demand during stationary vehicle operation, for example, during hitching or flatbed operations of commercial vehicles, it is expedient to switch on auxiliary electromotively driven air compressor 9.1. Auxiliary electromotively driven air compressor 9.1 permits selective operations of that kind also without the engine running, given sufficient power supply. This reduces the noise generation of the vehicle as well as possible exhaust-gas emissions of main drive engine 1.

Auxiliary electromotively driven air compressor 9.1 can be quickly available already during the starting in that it is switched on already at a high constant speed, for example, at the ignition key position “ignition on”. The annoying engine noise at high engine speed of main drive engine 1 for filling the compressed air system is thus eliminated.

To be quickly ready for starting, auxiliary electromotively driven air compressor 9.1 can be switched on via a timing circuit already before starting to drive in order to reach the drive-away pressure level. To minimize noise, this can be done at low air compressor speed. Quick readiness for starting can also be achieved in this manner via air compressor 9 when operated electromotively. The compressed air system of the vehicle is then filled and ready for service already when starting main drive engine 1.

What is claimed is:

1. A vehicle, in particular, a passenger or commercial vehicle, comprising:
a main drive engine;
an electric motor;
an air compressor drivable by the electric motor, and
an electric current source from which the electric motor is supplied,
the air compressor being drivably connected in a selective manner to the main drive engine or to the electric motor.

2. The vehicle as recited in claim 1 further comprising a power take-off transmission having an output drive, a first input drive and a second input drive, the air compressor being connected to the output drive, and, selectively, the first input drive being drivably connected to the main drive engine and a second input drive being drivably connected to the electric motor.

3. The vehicle as recited in claim 2 further comprising vehicle wheels and a drive train between the main engine wherein the vehicle wheels, the power take-off transmission being integrated into the drive train between the main drive engine and the vehicle wheels.

4. The vehicle as recited in claim 2 further comprising a drive train, the power take-off transmission being a part of a manual or automatic transmission provided in the drive train.

5. The vehicle as recited in claim 1 further comprising a fuel cell, the electric motor being supplied from the fuel cell during a standstill and/or at rotational speeds of the main drive engine below a minimum speed.

6. The vehicle as recited in claim 1 further comprising a fuel cell, the electric motor being electrically supplied from the fuel cell.

7. The vehicle as recited in claim 6 wherein the air compressor compresses ambient air to define oxygen-carrying process air, the process air being supplied to cells of the fuel cell and/or to a reformer.

8. The vehicle as recited in claim 1 further comprising an auxiliary electromotively driven air compressor.

9. The vehicle as recited in claim 8 further comprising a compressed air line, the auxiliary air compressor being connected in series with the air compressor with respect to the compressed-air line.

10. The vehicle as recited in claim 9 further comprising a non-return valve in the compressed air line between the auxiliary air compressor and the air compressor.

11. A method for operating a vehicle in particular, a passenger or commercial vehicle, comprising a main drive engine; an electric motor; an air compressor drivable by the electric motor, and an electric current source from which the electric motor is supplied, the method comprising the steps of:
driving the air compressor using the main drive engine in a first mode; and
driving the air compressor using the electric motor in a second mode.

12. The method as recited in claim 11 wherein the first mode is a normal operation and the second mode occurs when when a speed of drive engine is too low or is at a standstill.

13. The method as recited in claim 11 wherein the air compressor is driven by the drive engine during overrun and selectively by the drive engine or the electric motor during traction.

14. The method as recited in claim 11 further comprising selectively switching on an auxiliary electromotively driven air compressor.

15. The method as recited in claim 14 wherein the auxiliary air compressor is switched on in addition to the air compressor in case of an increased demand of compressed air during driving operation.

16. The method as recited in claim 14 wherein the auxiliary air compressor is automatically switched on when a demand of compressed air occurs while the main drive engine is at rest or is idling.

17. The method as recited in claim 14 wherein the auxiliary air compressor is switched on during a starting operation of the vehicle for filling a compressed air system.

18. The method as recited in claim 14 wherein the auxiliary air compressor is switched on prior to start up of the vehicle for filling a compressed air system.
